(19) United States
(12) Patent Application Publication
(10) Pub. No.: US 2018/0357682 A1
(43) Pub. Date: Dec. 13, 2018

(54) SYSTEMS AND METHODS FOR PLATFORM AGNOSTIC MEDIA INJECTION AND PRESENTATION

(71) Applicant: CLICK FLYP TECHNOLOGY, LLC, Brandywine, MD (US)

(72) Inventors: Harold Jackson, III, Brandywine, MD (US); Jovan L. Dungee, Greenville, SC (US)

(21) Appl. No.: 16/006,321

(22) Filed: Jun. 12, 2018

Related U.S. Application Data
(60) Provisional application No. 62/518,259, filed on Jun. 12, 2017.

(51) Int. Cl. G06Q 30/02; G06F 17/22; H04L 29/08; G06F 9/54; G06F 17/30

(52) U.S. Cl. CPC G06Q 30/0277; G06F 17/2235; G06F 17/30864; G06F 9/547; H04L 67/02

(57) ABSTRACT

Systems and methods for platform agnostic media injection and presentation are disclosed. According to certain aspects of the present disclosure, a model-view-controller application framework allows for additional media to be embedded into a pre-existing web platform. One aspect of the present disclosure allows for a selectable icon to be embedded into the web platform formatting. The application framework may be operable to read the web platform code and identify particular locations in the code wherein additional code may be injected for displaying the selectable icon(s). According to various aspects of the present disclosure, selecting the icon may trigger additional media to be presented within the web platform. Presenting additional media may include reversing present media to show a separate media item on the “opposite side”, or additional media may be presented onto within the web platform in a sliding motion.

### CROSS REFERENCE TO RELATED APPLICATIONS

This application claims the benefit of and priority to U.S. provisional patent application No. 62/518,259, filed on Jun. 12, 2017, and entitled “SYSTEMS AND METHODS FOR PLATFORM AGNOSTIC MEDIA INJECTION AND PRESENTATION,” the disclosure of which is incorporated by reference in its entirety as if the same were fully set forth herein.

### TECHNICAL FIELD

The present disclosure relates generally to systems and methods for platform agnostic media injection and presentation, and more particularly to modifying a display to include a targeted campaign based on user activity within a web platform.

### BACKGROUND

In general, typical web platforms (e.g., Facebook, Instagram, Snapchat, etc.) allow for additional media (i.e., advertisement campaigns) to be included in the current page or a viewable portion of the web platform. For example, an advertisement may be positioned between two separate Facebook posts, or various advertisements or news stories may be selectable within the Snapchat platform. Typically, these advertisement campaigns occupy a large portion of the display and the advertisement must be moved or scrolled off the display, unselected, or otherwise exited in order for a new advertisement to be displayed. In these scenarios, a user must reselect, re-scroll through, or otherwise navigate through the web platform in order to return to a certain location within the web platform. Therefore, there is a long-felt but unresolved need for systems and methods that allow for additional media to be created, injected, and presented within a web platform, allowing for a user to be presented with the additional media without having to compromise his/her current location within the web platform.

### SUMMARY OF DISCLOSURE

Briefly described, and according to one embodiment, aspects of the present disclosure generally relate to platform agnostic media injection and presentation. More specifically, the systems and methods relate to creating an advertisement campaign that may be injected into various digital and web platforms (e.g., Facebook, Instagram, Snapchat, etc.).

In one embodiment, the disclosed system comprises: a mobile computing device operable to support a software-based mobile application, the software-based mobile application comprising one or more software modules operable to access a processor and memory associated with the mobile computing device for receiving web data, wherein the one or more software modules modify the web data to display a plurality of view panes on a display at the mobile computing device; and a remote computing system in operative communication with the mobile computing device, wherein the remote computing system comprises one or more remote network components configured to: receive a REST API request from the mobile computing device comprising a request for particular web data, the REST API request identifying a particular SDK corresponding to the software-based mobile application; and transmit, to the mobile computing device, the particular web data in response to the REST API request, whereby the mobile computing device generates the plurality of view panes based on the particular web data and the particular SDK, wherein a first view pane comprises a display target location embedded with a HTTPS link to a second view pane.

In particular embodiments, the system includes aspects wherein the first view pane and/or second view pane are advertisements. In certain embodiments, in response to a user engaging the first view pane at the display target location, modifying the display to present the second view pane. In one embodiment, modifying the display to present the second view pane comprises rotatably replacing the first view pane with the second view pane. According to various aspects of the present disclosure, rotatably replacing the first view pane with the second view pane optically presents the second view pane as a reverse side of the first view pane. In various embodiments, modifying the display to present the second view pane comprises replacing the first view pane with the second view pane in response to the second view pane appearing to reveal from outside the display boundaries.

According to various aspects of the present disclosure, the HTTPS link to the second view pane is automatically embedded based on predictive analytic techniques. In particular embodiments, the predictive analytic techniques generate suggested advertisements in response to processing application activity from the user, the application activity comprising records of keystrokes, selected hyperlinks, and/or web browser history. In further embodiments, the remote computing system further comprises an SQL database for storing web data associated with the second view pane.

In one embodiment, a method is disclosed for displaying media within a mobile application to a user operating a mobile computing device, the method comprising the steps of: displaying, via a display of the mobile computing device, a first view pane to the user comprising first media, wherein a particular portion of the first view pane is selectable by the user and comprises an embedded HTTPS link to a second view pane; receiving, at the mobile computing device, an indication of user interaction with the particular portion of the first view pane; retrieving, via the embedded HTTPS link, web data corresponding to the second view pane, the web data comprising at least additional media corresponding to the second view pane; and modifying the display to present the second view pane, wherein modifying the display comprises rotatably replacing the first view pane with the additional media corresponding to the second view pane.

In various embodiments, the embedded HTTPS link is directed to a remote SQL database. In some embodiments, the first view pane and/or second view pane are advertisements. In particular embodiments, rotatably replacing the first view pane with the additional media corresponding to the second view pane optically presents the second view pane as a reverse side of the first view pane. According to various aspects of the present disclosure, modifying the display to present the second view pane comprises replacing the first view pane with the second view pane in response to the second view pane appearing to reveal from outside the display boundaries.

In one embodiment, the embedded HTTPS link to the second view pane is automatically embedded based on predictive analytic techniques. In various embodiments, the predictive analytic techniques generate suggested advertisements in response to processing application activity from the user, the application activity comprising records of keystrokes, selected hyperlinks, and/or web browser history. In certain embodiments, the embedded HTTPS link corresponds to a remote computing system operatively connected to the mobile computing device and comprising an SQL database for storing the additional media. In a particular embodiment, rotatably replacing the first view pane with the additional media corresponding to the second view pane optically presents the second view pane as a particular side of a multi-sided plurality of view panes.

These and other aspects, features, and benefits of the present systems and methods will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF DRAWINGS

Further features and benefits of the present disclosure will be apparent from a detailed description of various embodiments thereof taken in conjunction with the following drawings, wherein similar elements are referred to with similar reference numbers, and wherein:

FIG. 1A is a first screenshot of a mobile phone showing the exemplary application, according to one aspect of the present disclosure;

FIG. 1B is a second screenshot of a mobile phone showing the exemplary application, according to one aspect of the present disclosure;

FIG. 2 is a system architecture, according to one aspect of the present disclosure;

FIG. 3 is an application architecture, according to one aspect of the present disclosure;

FIG. 4 is a flowchart of the exemplary additional media creation process, according to one aspect of the present disclosure; and

FIG. 5 is a flowchart of the exemplary additional media presentation process, according to one aspect of the present disclosure.

### DETAILED DESCRIPTION

Briefly described, various aspects of the present disclosure generally relate to platform agnostic media injection and presentation. More specifically, the systems and methods relate to creating an advertisement campaign that may be injected into various digital and web platforms (e.g., Facebook, Instagram, Snapchat, etc.).

These and other aspects, features, and benefits of the present systems and methods will become apparent from the following detailed written description of the preferred embodiments and aspects taken in conjunction with the following drawings, although variations and modifications thereto may be effected without departing from the spirit and scope of the novel concepts of the disclosure.

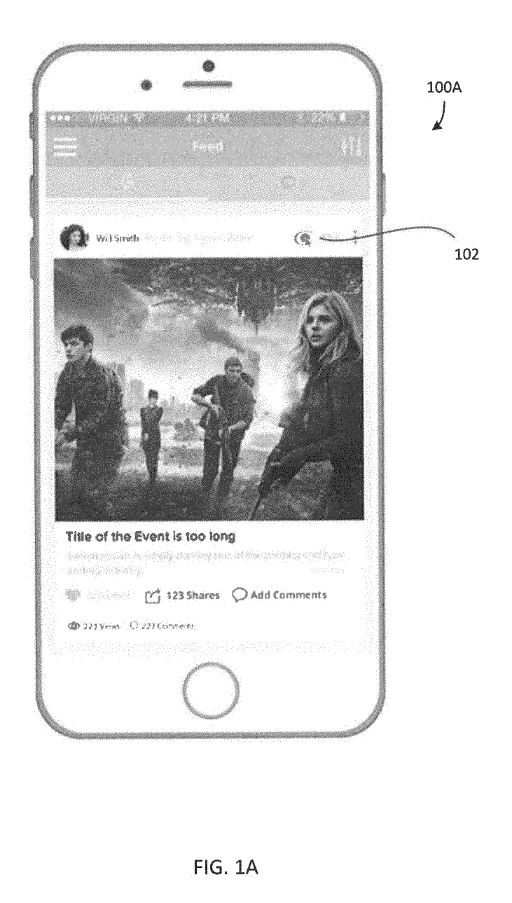

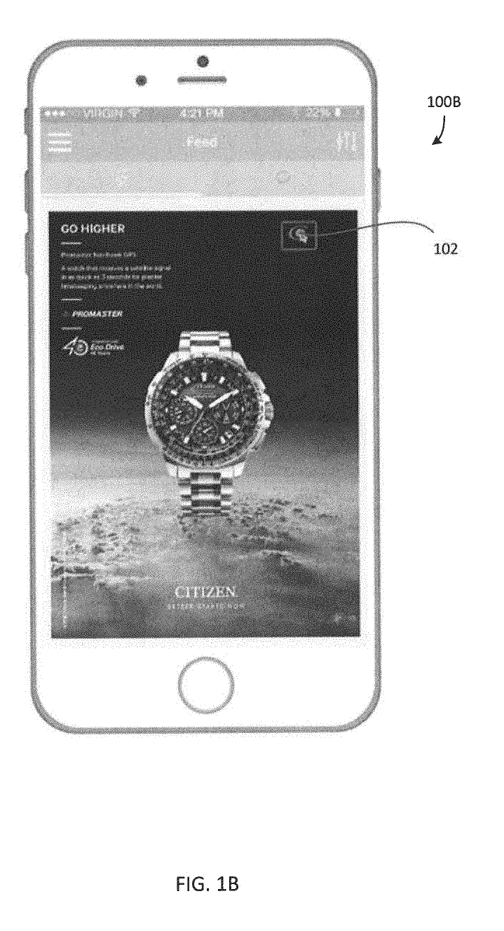

Turning now to FIG. 1A of the drawings, a smartphone screenshot shows a social media post 100A published on a web based platform, according to one aspect of the disclosure. In various embodiments, the web based platform may be any digital or social media platform (e.g., Facebook, Instagram, Snapchat, a proprietary platform, etc.) and may be run on various computing devices (e.g., smartphones, laptops, tablets, smartwatches, etc.). According to various aspects of the present disclosure, the present systems and methods allow for additional media to be injected into the web platform. In particular embodiments, injecting additional media into the web platform, or any appropriate digital medium, may include overlaying the additional media onto the preexisting web platform formatting or design. In certain embodiments, the additional media is embedded into the code or stylistic formatting of the preexisting web platform. According to one aspect of the present disclosure, and as seen in FIG. 1A, the icon 102 is embedded into a header or toolbar of a particular post on a web platform. In various embodiments, digital and web platforms may embed icons, such as the icon 102, into their respective platforms via tools such as software development kits (“SDKs”), which allow for the platforms to incorporate the functionality discussed in the present disclosure with preexisting platforms. In particular embodiments, the icon 102 may be embedded or located anywhere on the web platform application page.

According to particular aspects, selecting (e.g., touching, clicking with a mouse, etc.) the icon 102 may present another screen or additional media that is not viewable without selecting the icon 102. According to some aspects, the icon 102 may be invisible but may be activated by using certain hand gestures, increased touch pressure, or double tapping certain regions of the device screen. According to various aspects of the present disclosure, the functionality of the icon 102 may also operate without being selected (e.g., the functionality may operate after a predetermined amount of time). A user of the system may select any region of a social media platform or post therein to initiate the icon 102 functionality. As discussed in the description of FIG. 1B, selecting the icon 102 may result in the additional media being presented.

Turning now to FIG. 1B, the smartphone screenshot shows additional media 100B in place of the previously displayed social media post 100A, according to one aspect of the disclosure. In particular embodiments, the additional media may be an advertisement, a video clip associated with a published post, a picture, a puzzle, a game, etc. In some embodiments, the additional media may be included in an advertisement campaign. In one embodiment, the system may target users with particular advertisements by implementing artificial intelligence and analytics techniques (such as predictive analytics). For example, the system may monitor web-pages visited through various social media platforms, or the system may track web browser history (e.g., keystrokes, selected hyperlinks, etc.). In some embodiments, the system may be configured to generate random forests for determining an optimal advertisement to present to a particular user based on various criteria such as location, demographic, previously selected advertisements, etc. In certain embodiments, the user's interaction with the optimal advertisement (or lack thereof) may be used as an additional data point for further configuring the random forest to determine optimal advertisements. As will be discussed in the architecture descriptions below, the system includes various APIs for gathering targeted user data and automatically presenting users with the advertisements.

According to various aspects of the disclosure, if a user selects the icon 102 as shown in FIG. 1A, the additional media 100B may be presented on the screen (or display) of the computing device (e.g., a mobile computing device). In particular embodiments, the additional media 100B may occupy the entire space of the screen. In some embodiments, the additional media 100B may only occupy a portion of the screen. According to various aspects of the present disclosure, the additional media 100B may slide onto the screen (from either the top, bottom, or a side) or the social media post may appear to rotate and reveal the additional media 100B on the reverse side. According to one aspect of the present disclosure, reselecting the icon 102 may reverse the process of displaying the additional media 100B, and the original social media post 100A may be shown on the screen, such as in FIG. 1A. In one embodiment, reselecting the icon 102 (or a separate icon) may present further additional media, such that the user may continue to receive additional media in response to selecting an icon or the like (e.g., the icon 102). For example, rather than a social media post rotating on a single axis to reveal additional media “behind” the social media post, the post may rotate or pivot on more than one axis or plane (similar to rotating to different faces on a 20-sided die). In particular embodiments, the additional media may be a sound or audio notification.

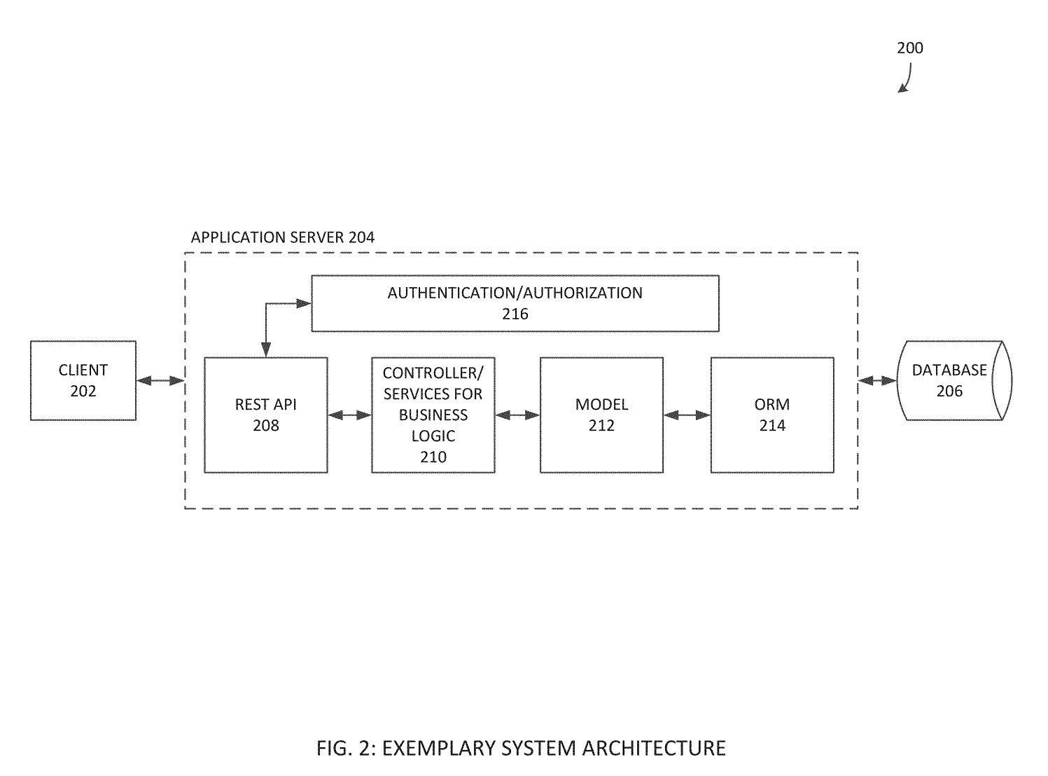

Continuing with FIGS. 1A and 1B, the functionality of the icon 102 may be distributed across various aspects of the media in the particular post. For example, consider a picture posted on a web platform including a dog and a water bowl. According to various aspects of the present disclosure, the functionality of the icon 102 may be integrated into the particular aspects of the posted picture. In this example, consider that a user selects the water bowl. In response to selecting the water bowl, the portion of the picture including the water bowl (or the entire picture) may rotate to reveal additional media (e.g., a link to a store where the water bowl is sold, additional pictures of the water bowl, a coupon for purchasing the water bowl, a video about the water bowl, etc.). Selecting the picture of the dog may trigger the system to present additional media associated with the local dog adoption center. In this example, and in various embodiments, the icon 102 may not be visibly present within the web platform. According to other aspects of the present disclosure, icons 102 will be included in the web platform to indicate what is selectable in the particular media post. The process of establishing and differentiating different selectable portions of the media will be discussed in greater detail in the description of FIG. 2.

FIG. 2 shows a system architecture diagram 200, according to one aspect of the present disclosure. In various embodiments, the system architecture includes a client 202, an application server 204, and a database 206. In certain embodiments, the application server 204 includes specialized servers and modules for performing specific tasks. In one embodiment, the application server 204 resembles a Sails framework. According to various aspects of the present disclosure, the system architecture may resemble any appropriate Model-View-Controller (MVC) web application framework. In general, a MVC framework is a web framework which promotes and supports back-end web development. According to certain aspects of the present disclosure, the web application framework includes a representational state transfer (REST) API 208, a controller and services for business logic 210, a model 212, an object relational mapping (ORM) tool 214, and authentication/authorization services 216.

According to one aspect of the present disclosure, the REST API 208 is a predefined set of instructions or operations that allow for the access and manipulation of web resources between computer systems in a network. In general, web resources and applications that are compliant with a REST API allow for a requesting device or node to manipulate certain aspects of the web application. For example, the REST API 208 in the present system may allow for the icon 102 to be embedded into particular web application toolbars. According to one aspect of the present disclosure, the authentication and authorization services 216 are integrated with the REST API 208 in order to protect user passwords and other identity related information that may be included in a web request.

According to various aspects of the present disclosure, the controller and services 210 for business logic allow for computing devices in a particular network to communicate. For example, a request for presenting additional media sent from a web browser, mobile application, or any other system capable of communicating with a server, as a result of a user selecting the icon 102, may be executed by the controller 210. According to one aspect of the present disclosure, the controller 210 includes the business logic associated with the present systems and methods. In particular embodiments, the business logic may be the portion of the system that encodes the real-world business rules which determine how data can be created, stored, and changed. In one embodiment, the system's business logic may determine what particular additional media is presented when the icon 102 is selected.

According to certain aspects of the present disclosure, the model 212 is a collection of structured data. According to some aspects of the present disclosure, the collection of structured data corresponds to a single table or collection of tables in a database. According to various aspects of the present disclosure, the model component of the system architecture allows for certain portions of code, which may represent additional media or the icon 102, to be used as templates for future development.

According to particular aspects of the present disclosure, the ORM tool 214 converts data between incompatible type systems. According to one aspect of the present disclosure, the ORM tool 214 is a storage and retrieval engine and provides an API for accessing various databases, protocols, and third-party APIs.

According to one aspect of the present disclosure, the system architecture 200 includes a database 206. In various embodiments, the database 206 may be a structured query language (SQL) formatted database. According to particular aspects of the present disclosure, a SQL formatted database allows for the data stored within the database 206 to be easily accessed, retrieved, and manipulated using a predetermined instruction set or syntax. According to other aspects of the present disclosure, the database 206 may be formatted as appropriate for various system configurations.

According to various aspects of the present disclosure, the client 202 included in the system architecture 200 is any computing device operable to connect to a computer network (e.g., desktop computer, tablet, smartphone, smartwatch, etc.). In one embodiment, the client 200 transmits and receives electronic commands and requests between the application server(s) 204. In particular embodiments, electronic commands and requests are REST API formatted. According to various aspects of the present disclosure, the client 202 is operable to execute and run web application frameworks such as Angular.js. According to one aspect of the present disclosure, web application frameworks, such as Angular.js, allow for cross-platform mobile application development. In certain embodiments, cross-platform mobile application development allows for a mobile application (such as a proprietary application) to be platform agnostic and execute identically on various devices and systems. In particular embodiments, the application distributed to the client 202 is a platform agnostic application. For example, a platform agnostic mobile application may execute, operate, and appear the same on a mobile phone as it would on a desktop web browser.

According to one aspect of the present disclosure, when injecting additional media into a web based application/resource, the web application framework (Angular.js) may first read/scan the code or formatting of the web resource (e.g., HTML, etc.). According to certain aspects of the present disclosure, the web resource may have custom tags or attributes embedded into the code, wherein the custom tags or attributes indicate locations in the formatting where additional code or formatting may be inserted. In particular embodiments, the web application framework may allow traditional HTML code and formatting to present dynamic content (e.g., mobile ads, videos, etc.) through two-way data binding. In various embodiments, two-way data binding allows for the automatic synchronization of models and view in the web application. In one embodiment, the custom attributes or tags of a web based application may allow for the icon 102 to be embedded into the locations as seen in FIGS. 1A and 1B.

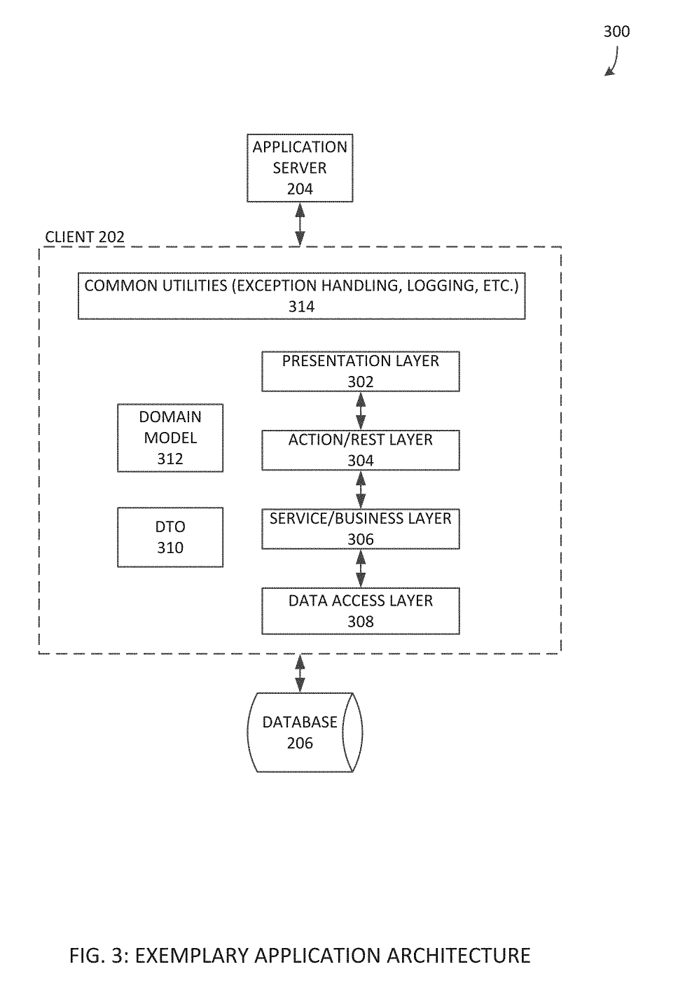

FIG. 3 shows the application architecture 300, according to one aspect of the present disclosure. In various embodiments, the application architecture 300 is device-local (e.g., resides at the client 202) and includes layers or tiers of different modules, wherein each module performs a specific role in the application. As seen in FIG. 3, the application architecture 300 includes a web presentation layer 302, an action layer 304, a service/business logic layer 306, a data access layer 308, a data transfer layer (DTO) 310, a domain model 312, and a common utilities layer 314. According to various aspects of the present disclosure, the database 206 is operable to transmit and receive electronic data between the data access layer 308.

According to particular aspects of the present disclosure, the web presentation layer 302 presents the application to the end user (via modifying a display). In order to present the application to the end user, the web presentation layer 302 may first transmit a HTTP request to the controller layer 210 in a particular form based on the current web platform being accessed. According to one aspect of the present disclosure, the web presentation layer 302 renders a user interface (UI) based on the response generated by the controller layer 210. According to a particular aspect of the present disclosure, the web layer 302 generally processes request parameters, HTTP sessions, and HTTP response codes. In various embodiments, the UI rendered by the web presentation layer 302 is also referred to herein as the “view layer.” In certain embodiments, the view layer is an independent resource included within the web presentation layer, where separating the functionality between the two layers maximizes the web presentation layer efficiency, latency, and throughput. In one embodiment, the view layer is separate from the other application architecture layers in order for the system to continue to process other requests (which require resources such as data connections) without having to wait on occupied network connections to become available. In particular embodiments, the process of rendering a response for a client request is separate from the process of gathering the response.

In one embodiment, the action layer 304 (also referred to herein as the controller) communicates information, requests, and responses between the web presentation layer 302 and the service/business logic layer 306. In various embodiments, the action layer 304 delegates to the service layer 306 for the coordination of the business logic.

In certain embodiments, the service/business logic layer 306 combines requests to and from the data access objects and the domain model objects by means of object relational mapping. According to certain aspects of the present disclosure, the service layer 306 does not have dependency on the view layer or web presentation layer.

According to particular aspects of the present disclosure, the data access layer 308 receives and persists instances of objects from the model 212. In one embodiment, the data access layer 308 is operable to interface with a persistence mechanism which stores and retrieves the object from the model 212. In particular embodiments, the access layer 308 may implement instructions operable to create, read, update, and delete memory elements. According to various aspects of the present disclosure, the data access layer 308 is implemented using data access objects. In particular embodiments, a data access object encapsulates the logic necessary to create, retrieve, update, and delete a domain object from a database. According to particular aspects of the present disclosure, the implementation of data access objects promotes overall database portability. In certain embodiments, the data access layer 308 allows for simplified data access by eliminating the need to execute low level and repetitive code. Additionally, and in various embodiments, the implementation of data access objects and a data access layer allows for easy transfer of data from the application layer to the system database 206, as well as allowing for the system to handle various datatype incompatibilities.

According to various aspects of the present disclosure, the domain model 312 includes a domain service, an entity and a value object. In one embodiment, a domain service is a stateless class that provides operations which are related to a domain concept. According to particular aspects of the present disclosure, an entity is an object that is defined by its identity which remains unchanged through the entire lifecycle of the entity. According to certain aspects of the present disclosure, a value object describes a property and does not have its own lifecycle or identity. In various embodiments, an exemplary objective of the domain model 312 is to handle data conversion as well as handle various operations (e.g., Insert, Delete, Update, etc.). In particular embodiments, domain objects are mapped in SQL to the database.

According to various aspects of the present disclosure, a data transfer object 310 is a data container operable to transmit or carry data between different processes and between the various layers of the application. In particular embodiments, implementing object relational mapping allows for the data transfer objects to be “invisible” from the client perspective and allow for the application to run more efficiently. In one embodiment, common utilities 314 are processes for exception handling, logging number generation, formatting dates, etc. In certain embodiments, the common utilities 314 may be modified to better suit the current system and application configurations.

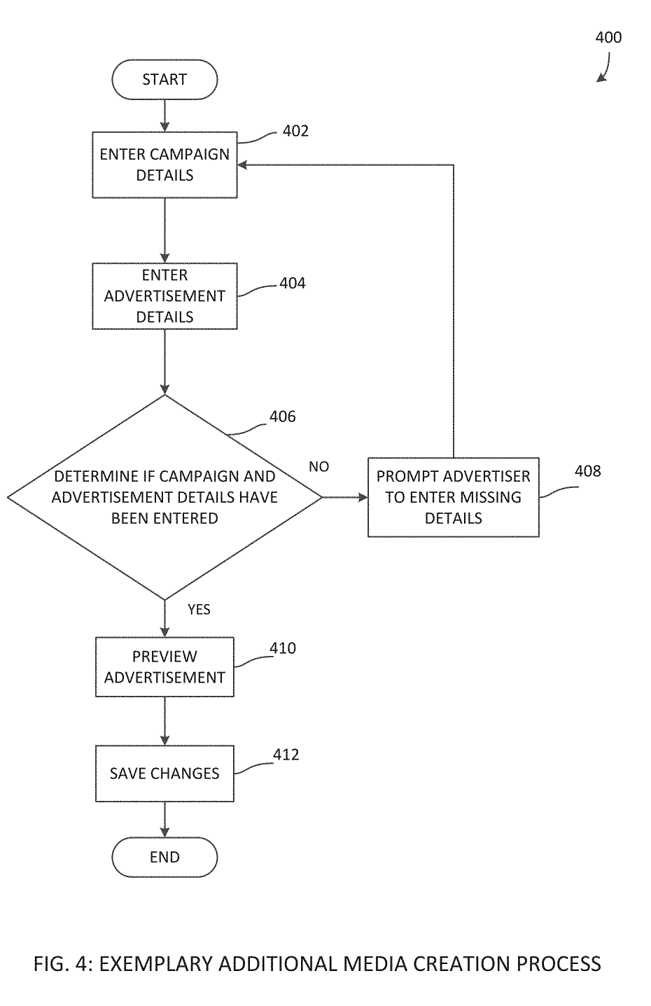

Proceeding now to FIG. 4, a flowchart is shown illustrating the exemplary additional media creation process 400, according to one aspect of the present disclosure. According to various aspects of the present disclosure, the additional media may be included in a campaign, such as an advertisement campaign. At step 402 a user may enter details regarding the campaign into the system. In one embodiment, the campaign details may include a campaign name, time period, budget, etc. In certain embodiments, the user may enter the campaign details into the system via a computing device such as a server, desktop computer, mobile device, or any appropriate device connected to a computer network. Proceeding to step 404, a user may enter specific advertisement details in connection with the additional media to be injected into the web application. In particular embodiments, advertisement details may include advertisement type, group, category, title, description, pictures and videos. For example, particular groups and categories may include gaming, travel, goods, shopping, etc. Particular advertisement types may include instant prizes wherein a user is automatically awarded a prize upon revealing the advertisement, or quests wherein a user may be required to complete a series of tasks in order to reveal the advertisement reward/incentive. As described in the discussion of step 402, a user may enter the advertisement details via a server, a desktop computer, or any other appropriate computing device connected to a computer network. According to some aspects of the present disclosure, at step 406 the system checks if both the campaign details and the advertisement details have been entered. If the campaign and advertisement details have not been sufficiently entered, the system may prompt the user to enter the missing details at step 408. If the campaign and advertisement details have been sufficiently entered, the process may proceed to step 410 where the user may preview the advertisement in connection with the additional media. According to one aspect of the present disclosure, the advertisement may be presented to the user on any device operable to run a web browser. Proceeding now to step 412, if the user is satisfied with the previewed advertisement, the user may save the advertisement and further publish the advertisement/additional media to any web based platform.

In various embodiments, once an advertisement is published, the system may track and store various statistics about the advertisement, referred to herein as “impressions”. According to one aspect of the present disclosure, the system may track particular impressions associated with the advertisement. In particular embodiments, the system may track impressions by trends, operating system, country, advertisements, geo-segment, and publisher. Additionally, the system may track the frequency or total amount an advertisement has been viewed, or how many times the icon 102 has been selected.

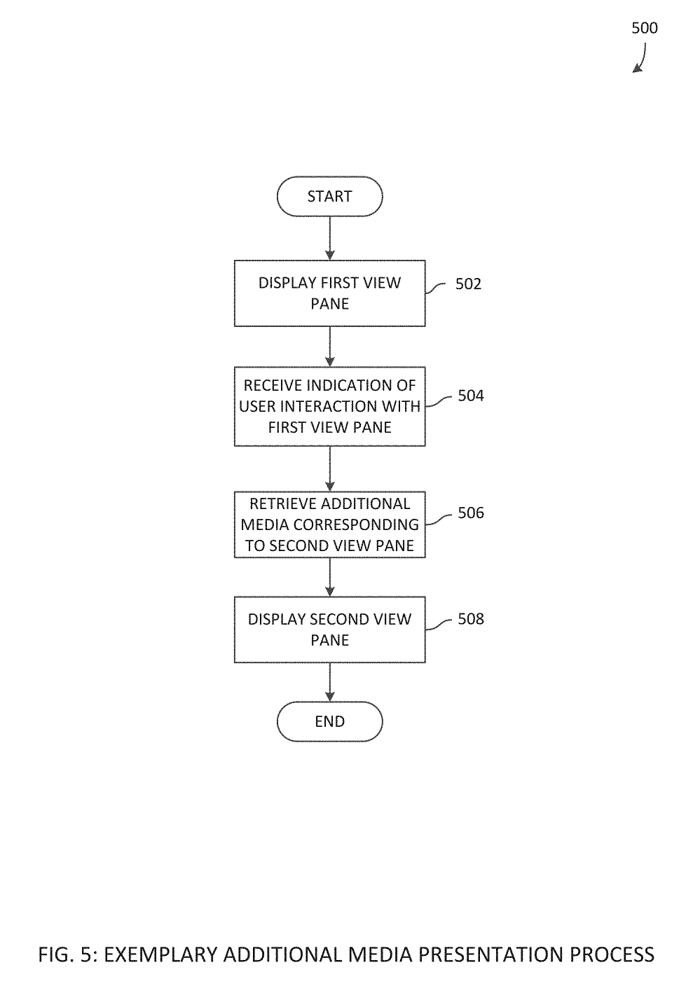

Referring now to FIG. 5, a flowchart is shown illustrating the exemplary additional media presentation process 500, according to one aspect of the present disclosure. In various embodiments, and as discussed herein, additional media may be presented to a user (via modifying a display) in response to the user engaging with a particular view pane on his/her mobile device. For example, the user may select an icon embedded within the view pane (e.g., a social media post), perform a hand gesture, or select a particular portion of the view pane (e.g., a product or item within the view pane) for initiating the presentation of the additional media. In particular embodiments, the exemplary additional media presentation process 500 begins at step 502, where the system displays a first view pane. In various embodiments, the first view pane may be any media type such as a picture, a video, a GIF, an advertisement, etc. In some embodiments, the first view pane may be a pop-up advertisement, or the first view pane may be located between two unrelated posts on scrollable social media feed. It should be understood that the first view pane may be presented to the user in a variety of ways on a variety of platforms.

Proceeding now to step 504, the system may receive an indication of user interaction with the first view pane, according to one aspect of the present disclosure. As discussed immediately above, the first view pane may include an icon (or the like), where the icon is selectable by the user. In particular embodiments, the user may select the icon via touching the icon, pointing-and-clicking with a mouse, performing hand gestures and/or voice commands, or any other appropriate method for communicating his/her intent to the mobile computing device. In some embodiments, the icon may be invisible to the user and embedded into the media of the first view pane (e.g., a particular portion or region of the media corresponds to the invisible icon).

In one embodiment, and in response to the user interaction with the first view pane, the system may retrieve additional media corresponding to a second view pane at step 506. In various embodiments, the first view pane may include an embedded HTTPS link (associated with the icon and/or selectable region) to web data and/or additional media corresponding to a second view pane. In particular embodiments, the additional media may be stored in a remote database, and the additional media may be retrievable via REST API calls.

Proceeding now to step 508, the system displays the second view pane, according to one aspect of the present disclosure. In various embodiments, displaying the second view pane includes modifying the display of the mobile computing device such that the first view pane is replaced by the second view pane. In particular embodiments, the web data associated with the additional media may include instructions or rules for displaying the additional media. For example, based on the instructions or rules, the mobile computing device may determine to rotate the first view pane to display the second view pane, gradually “slide” the second view pane onto the computing device display, etc. In various embodiments, the mobile computing device may modify the display to present the second view pane while preserving the look and feel of the current platform, web browser, etc. As discussed herein, the process 500 may end in response to displaying the second view pane at step 508, or, in some embodiments, the user may continue to receive additional media.

### CONCLUSION

Aspects, features, and benefits of the claimed systems and methods will become apparent from the information disclosed in the exhibits and the other applications as incorporated by reference. Variations and modifications to the disclosed systems and methods may be effected without departing from the spirit and scope of the novel concepts of the disclosure. It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and methods to the precise forms disclosed. Many modifications and variations are possible in light of the above teaching.

The embodiments were chosen and described in order to explain the principles of the systems and methods and their practical application so as to enable others skilled in the art to utilize the systems and methods and various embodiments and with various modifications as are suited to the particular use contemplated. Alternative embodiments will become apparent to those skilled in the art to which the present systems and methods pertain without departing from their spirit and scope. Accordingly, the scope of the present systems and methods is defined by the appended claims rather than the foregoing description and the exemplary embodiments described therein.

1. A system comprising:
a mobile computing device operable to support a software-based mobile application, the software-based mobile application comprising one or more software modules operable to access a processor and memory associated with the mobile computing device for receiving web data, wherein the one or more software modules modify the web data to display a plurality of view panes on a display at the mobile computing device; and
a remote computing system in operative communication with the mobile computing device, wherein the remote computing system comprises one or more remote network components configured to:
receive a REST API request from the mobile computing device comprising a request for particular web data, the REST API request identifying a particular SDK corresponding to the software-based mobile application; and
transmit, to the mobile computing device, the particular web data in response to the REST API request,
whereby the mobile computing device generates the plurality of view panes based on the particular web data and the particular SDK, wherein a first view pane comprises a display target location embedded with a HTTPS link to a second view pane.

2. The system of claim 1, wherein the first view pane and/or second view pane are advertisements.

3. The system of claim 1, wherein in response to a user engaging the first view pane at the display target location, modifying the display to present the second view pane.

4. The system of claim 3, wherein modifying the display to present the second view pane comprises rotatably replacing the first view pane with the second view pane.

5. The system of claim 4, wherein rotatably replacing the first view pane with the second view pane optically presents the second view pane as a reverse side of the first view pane.

6. The system of claim 3, wherein modifying the display to present the second view pane comprises replacing the first view pane with the second view pane in response to the second view pane appearing to reveal from outside the display boundaries.

7. The system of claim 1, wherein the HTTPS link to the second view pane is automatically embedded based on predictive analytic techniques.

8. The system of claim 8, wherein the predictive analytic techniques generate suggested advertisements in response to processing application activity from the user, the application activity comprising records of keystrokes, selected hyperlinks, and/or web browser history.

9. The system of claim 1, wherein the remote computing system further comprises an SQL database for storing web data associated with the second view pane.

10. A method for displaying media within a mobile application to a user operating a mobile computing device, the method comprising the steps of:
displaying, via a display of the mobile computing device, a first view pane to the user comprising first media, wherein a particular portion of the first view pane is selectable by the user and comprises an embedded HTTPS link to a second view pane;
receiving, at the mobile computing device, an indication of user interaction with the particular portion of the first view pane;
retrieving, via the embedded HTTPS link, web data corresponding to the second view pane, the web data comprising at least additional media corresponding to the second view pane; and
modifying the display to present the second view pane, wherein modifying the display comprises rotatably replacing the first view pane with the additional media corresponding to the second view pane.

11. The method of claim 10, wherein the embedded HTTPS link is directed to a remote SQL database.

12. The method of claim 10, wherein the first view pane and/or second view pane are advertisements.

13. The method of claim 10, wherein rotatably replacing the first view pane with the additional media corresponding to the second view pane optically presents the second view pane as a reverse side of the first view pane.

14. The method of claim 10, wherein modifying the display to present the second view pane comprises replacing the first view pane with the second view pane in response to the second view pane appearing to reveal from outside the display boundaries.

15. The method of claim 10, wherein the embedded HTTPS link to the second view pane is automatically embedded based on predictive analytic techniques.

16. The method of claim 15, wherein the predictive analytic techniques generate suggested advertisements in response to processing application activity from the user, the application activity comprising records of keystrokes, selected hyperlinks, and/or web browser history.

17. The method of claim 10, wherein the embedded HTTPS link corresponds to a remote computing system operatively connected to the mobile computing device and comprising an SQL database for storing the additional media.

18. The method of claim 10, wherein rotatably replacing the first view pane with the additional media corresponding to the second view pane optically presents the second view pane as a particular side of a multi-sided plurality of view panes.
